(19) United States
(12) Patent Application Publication
(10) Pub. No.: US 2006/0242130 A1
(43) Pub. Date: Oct. 26, 2006

(54) Information retrieval using conjunctive search and link discovery

(75) Inventors: Reza Sadri, Irvine, CA (US); Payman Arabshahi, Bellevue, WA (US); Jafar Adibi, Los Angeles, CA (US); Faramarz Jalalian, Aliso viejo, CA (US); Alireza Farmad, Pasadena, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Clenova, LLC

(21) Appl. No.: 11/398,199

(22) Filed: Apr. 4, 2006

Related U.S. Application Data
(60) Provisional application No. 60/674,144, filed on Apr. 23, 2005.

(51) Int. Cl. G06F 17/30

(52) U.S. Cl. 707/3

(57) ABSTRACT

An embodiment of the present invention is a technique for information retrieval. Information is searched using a set of search inputs representing a query from a user to produce a plurality of search results. The search results are analyzed using at least one of a conjunctive search, a link discovery, and a knowledge base to generate enhanced search results.

### RELATED APPLICATION

The present application claims the benefit of the U.S. provisional application, titled “System And Methods For Conjunctive Search And Link Discovery,” Ser. No. 60/674,144, filed Apr. 23, 2005.

### BACKGROUND 1. Field of the Invention

Embodiments of the invention relate to the field of information retrieval, and more specifically, to conjunctive search and link discovery. 2. Description of the Related Art

Search engines for retrieving information distributed across networks have been in use for years. Typical examples of such search engines and their associated search algorithms include those targeting the World Wide Web (“web”), such as Google, MSN Search, and Yahoo Search.

Current techniques for web search are replete with deficiencies. To perform a search on the web, a user typically uses a web browser, such as Microsoft's Internet Explorer, or Mozilla Firefox. The user enters one or more keywords (search terms) into a search engine of choice, via the browser. In response, the browser generates a query request to that search engine. The search engine then returns a list of result links to the browser, which in turn, displays the list to the user.

The main problem with conventional search engines is that they are unable to address search queries based on two or more disparate clues, in two or more unrelated documents distributed over a network. By way of an example, consider the case of a user who sets out to identify, via a search query to an Internet search engine, persons serving on the faculty of Stanford University's Computer Science Department, who also ran in the 2004 Big Sur Marathon. The answer here can only be found by correlating or matching two lists of names (Stanford Computer Science faculty, and Big Sur Marathon participants), and finding which names are in common between the two lists. Current search engines, and their underlying algorithms, focus on single or multiple keyword searches within single documents, at best moderated via Boolean operators supplied by the user. No current search engine algorithm performs conjunctive matching or correlation of multiple documents, rooted in multiple clues and based on partial information, to arrive at answers. Current search engines look for known, supplied keywords in documents, and are helpless when the user is searching for an unknown keyword, based on certain clues about that keyword. As such, current search engine algorithms lack the facility of truly investigative queries.

Another problem with current conventional search engines is that their algorithms lack useful and sophisticated deductive capabilities. Such a capability would not only involve observing multiple sources and drawing correlations (as described above), but also pruning the results to a manageable set, presenting it to the user, and then using user feedback to learn, adapt, and improve search engine performance. Current search engines are essentially one-way streets which provide a plethora of links to be navigated by the user, most of them not entirely relevant or useful, without much user feedback or input besides the few keywords typed in the form of an initial query. Refinement of the query, reduction of search space results, and arrival at meaningful conclusions and deductions is entirely the responsibility of the user, with its associated costs in time and effort, and often times lack of a decisive, accurate, and correct final answer.

Another problem with conventional search engines is they are not equipped in any way to perform link discovery, or the unraveling of links and relationships not just among multiple documents, but more importantly among many people, among numerous files such as images, audio, and video, and among many virtual or legal entities, based on information accessible from a source such as the web or a database.

### BRIEF DESCRIPTION OF THE DRAWINGS

Embodiments of invention may best be understood by referring to the following description and accompanying drawings that are used to illustrate embodiments of the invention. In the drawings:

FIG. 1A is a diagram illustrating a system in which one embodiment of the invention can be practiced.

Figure 1B is a diagram illustrating a client system according to one embodiment of the invention.

FIG. 2 is a diagram illustrating an information retrieval system according to one embodiment of the invention.

FIG. 3 is a diagram illustrating a search engine according to one embodiment of the invention.

FIG. 4 is a diagram illustrating an analyzer according to one embodiment of the invention.

FIG. 5 is a diagram illustrating a link discovery processor according to one embodiment of the invention.

FIG. 6 is a diagram illustrating a search refiner according to one embodiment of the invention.

FIG. 7 is a flowchart illustrating a process to perform information retrieval according to one embodiment of the invention.

FIG. 8 is a flowchart illustrating a process to search the information according to one embodiment of the invention.

FIG. 9 is a flowchart illustrating a process to analyze the search results according to one embodiment of the invention.

FIG. 10 is a flowchart illustrating a process to detect the relationships according to one embodiment of the invention.

FIG. 11 is a flowchart illustrating a process to rank the items according to one embodiment of the invention.

FIG. 12 is a flowchart illustrating a process to rank the items according to one embodiment of the invention.

FIG. 13 is a flowchart illustrating a process to refine searching according to one embodiment of the invention.

### DESCRIPTION

An embodiment of the present invention is a technique for information retrieval. Information is searched using a set of search inputs representing a query from a user to produce a plurality of search results. The search results are analyzed using at least one of a conjunctive search, a link discovery, and a knowledge base to generate enhanced search results.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention is a technique to retrieve information. The technique includes (1) searching information using a set of search inputs representing a query from a user to produce a plurality of search results; (2) analyzing the search results using at least one of a conjunctive search, a link discovery, and a knowledge base to generate enhanced search results; (3) refining searching using the enhanced search results; and (4) constructing the knowledge base using at least one of a Bayesian network, an expert system, and a rule-based system.

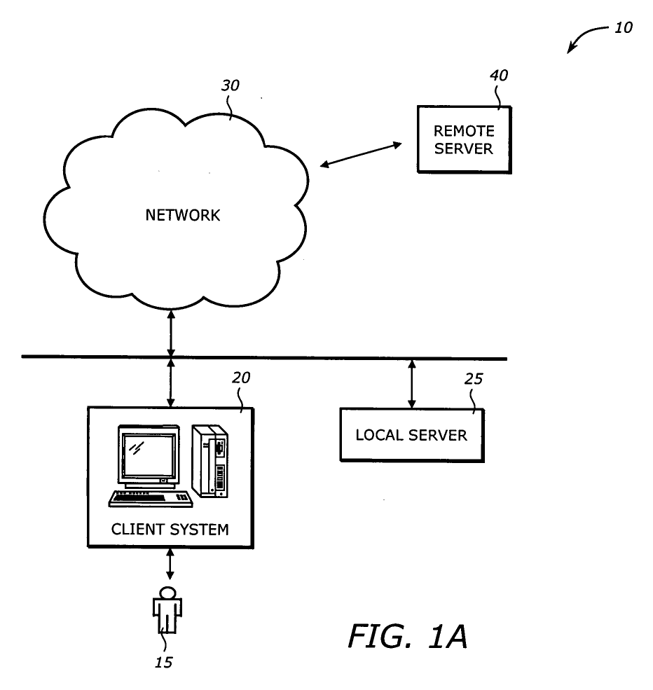

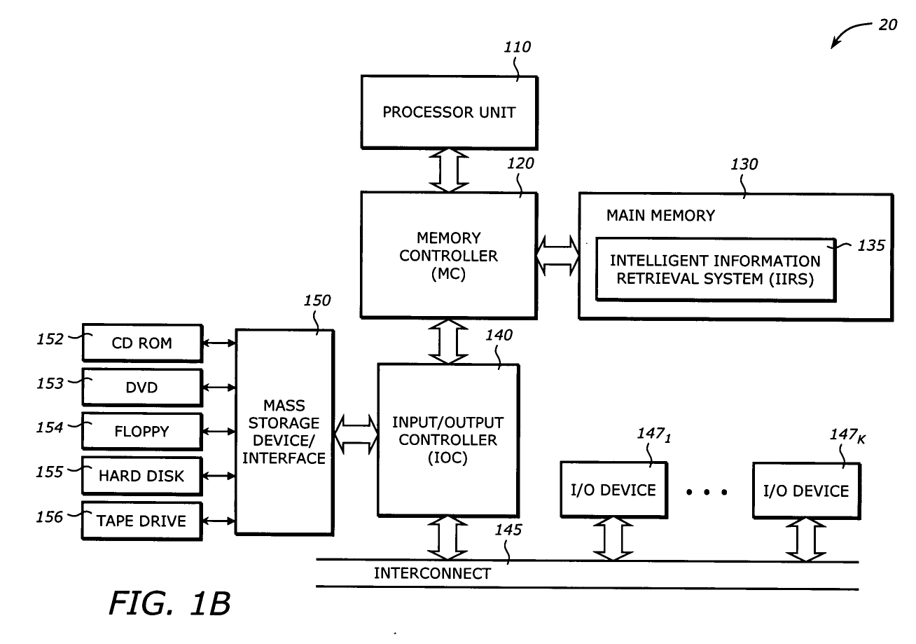

FIG. 1A is a diagram illustrating a system 10 in which one embodiment of the invention can be practiced. The system 10 includes a user 15, a client system 20, a local server 25, a network 30, and a remote server 40.

The user 15 may be a person, an entity, a client, a computer system, or a workstation, or any entity that performs information retrieval or searches for information. The client system 20 may be a computer system, a workstation, a notebook, a laptop, a personal digital assistant (PDA), a mobile unit, or any device that may contain an intelligent information retrieval system.

The local server 25 may be any computer system or server that is local to the client system 20. The local server 25 may be directly connected to the client system 20 via a local communication interface including wireless communication. The local server 25 may have a mass storage unit that contain at least an information base from which the user 15 wishes to search for information. The information base may include a database, a set of databases, a file storage volume, text and media, (e.g., audio, video, graphics, image), or other types of information storage, formatting, and organization base.

The network 30 may be any network that links the client system 20 and/or the local server 25 to other networks, client systems, or remote servers such as the remote server 40. The network 30 may be an intranet, extranet, local area network (LAN), wide area network (WAN), Internet, etc. The network 30 may be wired or wireless.

The remote server 40 may be any server that is connected to the network 30. It may contain at least an information base from which the user 15 may retrieve the search information. The information base may include a database, a set of databases, a file storage volume, text and media, (e.g., audio, video, graphics, image), or other types of information storage, formatting, and organization base.

FIG. 1B is a diagram illustrating a client system 20 in which one embodiment of the invention can be practiced. The system 20 may be a platform, a unit, a fully or partly configured system. It includes a processor unit 110, a memory controller (MC) 120, a main memory 130, an input/output controller (IOC) 140, an interconnect 145, a mass storage interface 150, and input/output (I/O) devices 147₁ to 147ₖ.

The processor unit 110 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. The processor unit 110 may be composed of one or more 32-bit or 64-bit microprocessors.

The MC 120 provides control and configuration of memory and input/output devices such as the main memory 130 and the IOC 140. The MC 120 may be integrated into a chipset that integrates multiple functionalities such as graphics, media, isolated execution mode, host-to-peripheral bus interface, memory control, power management, etc. The MC 120 or the memory controller functionality in the MC 120 may be integrated in the processor unit 110. In some embodiments, the memory controller, either internal or external to the processor unit 110, may work for all cores or processors in the processor unit 110. In other embodiments, it may include different portions that may work separately for different cores or processors in the processor unit 110.

The main memory 130 stores system code and data. The main memory 130 is typically implemented with dynamic random access memory (DRAM), static random access memory (SRAM), or any other types of memories including those that do not need to be refreshed. The memory 130 may include multiple channels of memory devices such as DRAMs. The memory 130 may include an intelligent information retrieval system (IIRS) 135. The information retrieval system 135 may be implemented by hardware, software, firmware, or any combination thereof. The memory 130 may contain the IIRS 135 completely or partly. When the memory 130 contains the IIRS 135 partly, the remaining parts of the IIRS 135 may be located externally to main memory 130 or the client system 20.

The IOC 140 has a number of functionalities that are designed to support I/O functions. The IOC 140 may also be integrated into a chipset together or separate from the MC 120 to perform I/O functions. The IOC 140 may include a number of interface and I/O functions such as peripheral component interconnect (PCI) bus interface (legacy and/or Express), processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 145 provides interface to peripheral devices. The interconnect 145 may be point-to-point or connected to multiple devices. For clarity, not all interconnects are shown. It is contemplated that the interconnect 145 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 150 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read only memory (ROM) 152, digital video/versatile disc (DVD) 153, floppy drive 154, and hard drive 155, tape drive 156, and any other magnetic or optical storage devices. The mass storage device provides a mechanism to read machine-accessible media.

The I/O devices 147₁ to 147_{K} may include any I/O devices to perform I/O functions. Examples of devices 147₁ to 147_{K} include controllers for input devices (e.g., keyboard, mouse, trackball, pointing device), media cards (e.g., audio, video, graphic), network cards, and any other peripheral controllers.

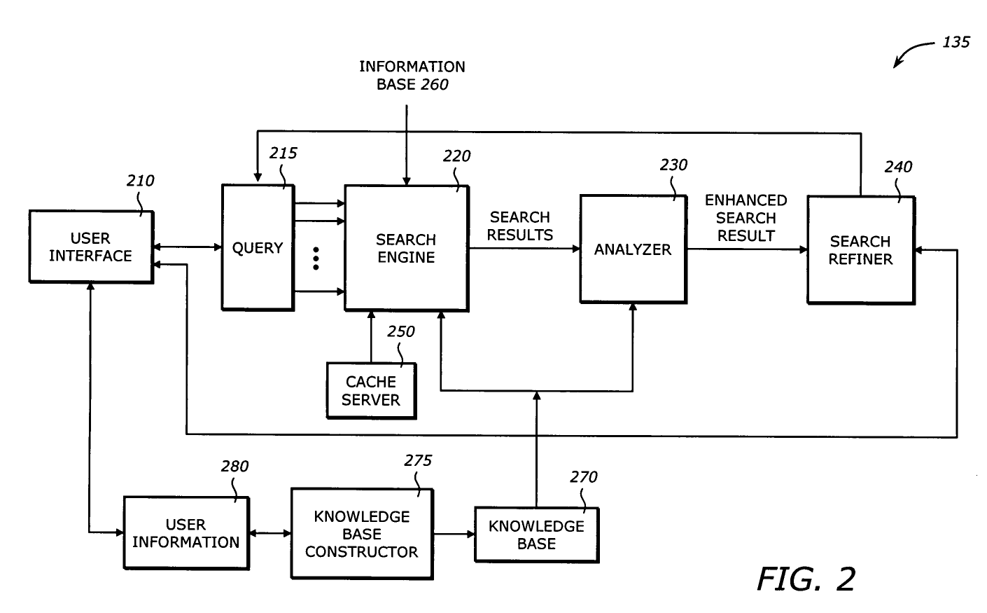

FIG. 2 is a diagram illustrating the intelligent information retrieval system (IIRS) 135 shown in FIG. 1B according to one embodiment of the invention. The IIRS 135 includes a user interface 210, a search engine 220, an analyzer 230, a search refiner 240, a knowledge base 270, and a knowledge base constructor 275. It is contemplated that the IRS 135 may contain more or less than the above components. Any of the above elements may be implemented partly or fully by hardware, software, firmware or any combination thereof.

The user interface 210 provides an interface to the user 15. It may be implemented as a graphical user interface (GUI) with menus, icons, and navigation facilities to allow the user to interact with the IIRS 135 during a search session. The user interface 210 allows the user 15 to enter a query 215 in the form of a number of search inputs. The search inputs may be in any suitable form. They may be in the form of a textual string (e.g., key words), a file descriptor, a media file, a metadata tag, or any forms that are used for searching information. It may allow the user 15 to enter user profile, user information and preferences. It may receive refined search results from the search refiner 240 and present the refined search results to the user 15. It may receive feedback or inputs from the user 15 regarding the refined search results so that the feedback may be used to update the knowledge base 270.

The search engine 220 performs searching information using the search inputs. The information may be a textual document, an image, a video file, an audio file, and a media file. The text document may be an HyperText Markup Language (HTML), an eXtensible Markup Language (XML) document, a Web page, or any other textual document. The search engine 220 may find a match for the search inputs from an information base 260. The information base 260 may be located locally or remotely. The remote information base may be a Web source or a remotely located database. An example of such a search operation is web search. Another example of such an operation is a search across a database or multiple databases which may or not be web-accessible. Another example of such an operation is correlating multiple sets of search results based on a pre-defined metric, for instance determining, within a given zip code, all locations of businesses of type B (e.g. hotels) which are within X miles of a specific location of a business of type B (e.g. photocopy/business services shop). Yet another example of such an operation is information retrieval via communications across the network 30.

The search engine 220 may use information or data stored on a cache server 250 and/or the knowledge base 270 to provide the search information, or a combination of them. The cache server 250 may contain recently searched items and may provide these items for fast retrieval. The purpose of the cache server 250 is to make a large database of previously retrieved and stored data readily available. Such data can be in the form of fetched and stored web sites in an offline fashion, or other types of data. The cache server 250 thus mitigates the need for an online network or web connection which may not be available or easily accessible at all times. The cache server 250 therefore aids in improving the overall speed of operation of the IIRS 135. The cache server 250 is itself architected and implemented for efficient and speedy operation.

The analyzer 230 analyzes the search results provided by the search engine 220 to generate enhanced search results using at least one of a conjunctive search, a link discovery, and the knowledge base 270. The conjunctive search is a search that connects or links the search attributes obtained from the search results. The link discovery discovers any relationships among the search attributes to reinforce, rank, or categorize the search results so that new items may be generated, deduced or inferred.

The search refiner 240 refines the enhanced search results provided by the analyzer 230. It may present the enhanced search results to the user 15 via the user interface 210 and receive feedback, comments, or selection from the user 15. It may update the query 215 and/or the knowledge base 270 either automatically or using the feedback from the user 15.

The knowledge base (KB) 270 contains knowledge information regarding the search. It may be constructed and maintained by a knowledge base constructor 275. It may be updated by the search refiner 240. The KB constructor 275 constructs the KB 270 using user information 280 including user history, user preferences, or user selection. It may add new information to or delete obsolete information from the KB 270. It may represent the knowledge using a Bayesian network, an expert system, and a rule-based system. The purpose of the knowledge base 270 is to make a large database of previously processed data, inference rules, algorithms, and clean, filtered results of data processing readily available. The knowledge base 270 thus mitigates the need for constant or frequent human intervention to make corrections or to perform intelligent fine tuning. The knowledge base 270 therefore aids in improving the overall accuracy and correctness of the results of the IIRS 135. The knowledge base 270 is itself architected and implemented for efficient, intelligent, and speedy operation. Examples of technologies incorporated within the knowledgebase server are text and information mining, information and communication theories, multi-criteria optimization, statistical machine learning, and link discovery and social network analysis.

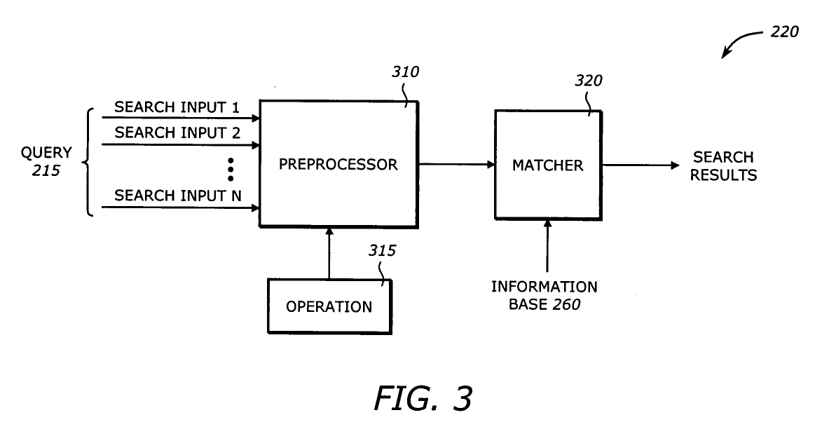

FIG. 3 is a diagram illustrating the search engine 220 shown in FIG. 2 according to one embodiment of the invention. The search engine 220 includes a pre-processor 310 and a matcher 320.

The pre-processor 310 performs a pre-processing on the search inputs representing the query 215. It may perform an operation 315 on the search inputs. The operation 315 may be at least one of a lexical operation, a logical operation, a semantic operation, a filtering operation, a mathematical operation, and a null operation. The lexical operation may generate a vocabulary, parse a phrase, or apply a grammar rule to a phrase. A logical operation may apply a logic operation (e.g., AND, OR, XOR) to combine or split the search inputs. A semantic operation may define a word or descriptor, interpret a phrase, or generate a new word or phrase. A filtering operation may merge words or phrases, reduce a string, or eliminate redundancy. For example, punctuation marks or words that are not useful for search such as “is”, “the”, “an”, may be eliminated. A mathematical operation may apply an arithmetic operation, a formula, or an equation to the search inputs. A null operation does nothing and passes the searchinputs unchanged. For example, the search inputs may include keywords “the image” and “person”. The pre-processor 310 may apply any combinations of the above operations and produce new keywords which include “(image OR picture) AND (man OR woman OR child OR people OR person)”.

The pre-processor 310 may pre-process the search inputs using at least one of the cache server 250 and the knowledge base 270.

The matcher 320 matches the pre-processed query with the information base 260. The matching may use any suitable matching technique. For example, the matcher 320 may compare a text string with a text document. It may match metadata tags. It may match a file descriptor with a file. The matcher 320 obtains the search results from the information base 260 that match with the pre-processed query.

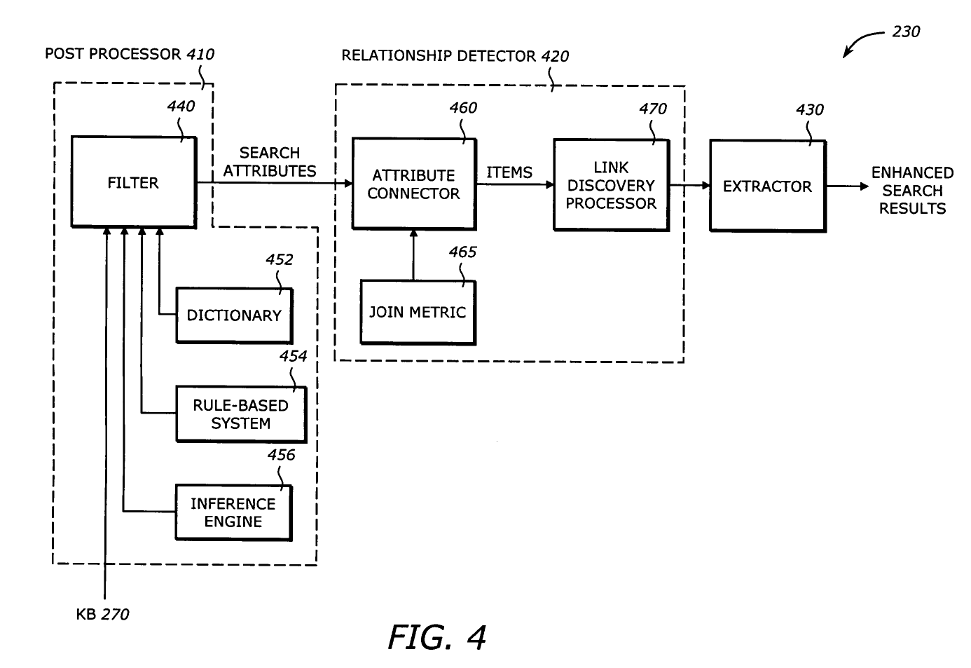

FIG. 4 is a diagram illustrating the analyzer 230 shown in FIG. 2 according to one embodiment of the invention. The analyzer 230 includes a post processor 410, a relationship detector 420, and an extractor 430.

The post processor 410 post processes the search results to generate search attributes. The post processor 410 may include a filter 440. The filter 440 may filter the search results using at least one of a dictionary 452, the KB 270, a rule-based system 454, and an inference engine 456.

The relationship detector 420 detects relationships or links among the search attributes to generate classification of items derived from the search attributes. The classification may be in a form of a grouping or a ranking of the items. The relationship detector 420 may include an attribute connector 460 and a link discovery processor 470. The attribute connector 460 connects the search attributes based on a join metric 465 to produce items. The join metric 465 may be at least one of a matching metric, a spatial metric, a temporal metric, a semantic metric, and a contextual metric. The matching metric may correspond to similarity between attributes. For example, “house” may be more similar to “hose” than “housing”. The spatial metric corresponds to distance between attributes according to the position of the attributes in the search results. The temporal metric may correspond to the recency of the attributes. The semantic metric may correspond to the meaning of the attributes. For example, “house” is closer to “housing”than to “hose”. The contextual metric may correspond to the context of the attributes according to some pre-defined criteria. The link discovery processor 470 performs a link discovery on the items to obtain the relationships.

The extractor 430 extracts the enhanced search results from the detected relationships among the items. The enhanced search results may include new search attributes that are inferred or deduced from the relationships. The enhanced search results may also include a ranking of the items or the search attributes.

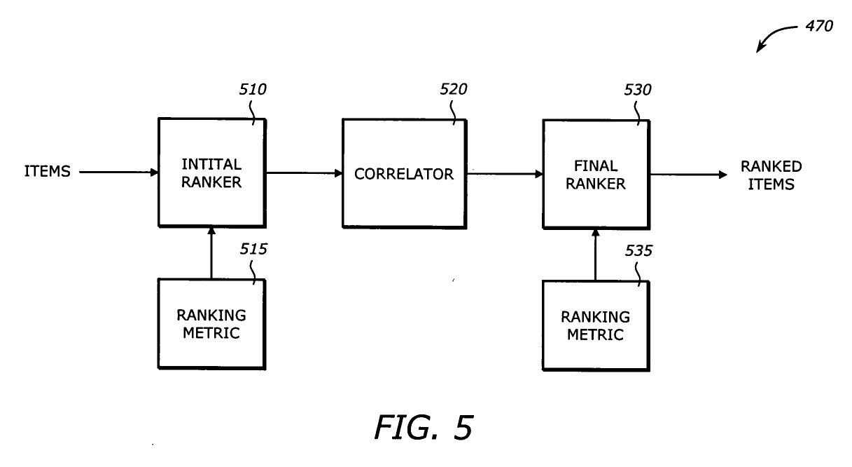

FIG. 5 is a diagram illustrating the link discovery processor 470 shown in FIG. 4 according to one embodiment of the invention. The link discovery processor 470 may perform a ranking of the items provided by the attribute connector 460. It may include an initial ranker 510, a correlator 520, and a final ranker 530.

The initial ranker 510 produces an initial ranking of the items using a ranking metric 515. The initial ranking may be performed according to a variety of algorithms for instance, ranking documents with higher information content, as measured by document entropy, as higher. By way of an example, a document written with many different words taken from a rich vocabulary (e.g., literary work, scientific paper) will have a higher entropy or information content than a document written with essentially similar words, taken from a simple vocabulary (e.g., children's story) and could thus be ranked higher. The correlator 520 generates a correlation result from the initial ranking of the items. This may be performed via intersection of the post-processed and ranked results, to discover keywords that are common between the retrieved sets of documents corresponding to each initial input search term. The final ranker 530 generates a final ranking of the items based on the correlation result using a ranking metric 535. The ranking metrics 515 or 535 may include at least one of information content, a frequency of occurrences of the items, and a commonality metric between the items and the search. For example, less frequent keywords, as measured by aggregate number of occurrence of the keyword, may be ranked as higher, thus giving more weight to more unique keywords.

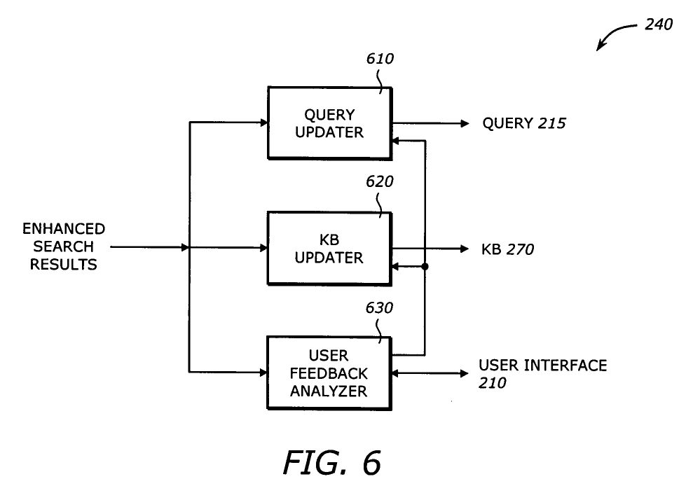

FIG. 6 is a diagram illustrating the search refiner 240 shown in FIG. 2 according to one embodiment of the invention. The search refiner 240 includes a query updater 610, a KB updater 620, and a user feedback analyzer 630.

The query updater 610 updates the query 215 using the enhanced search results. For example, the query 215 may include keywords “Stanford faculty” and “marathon runner”. The query updater 610 may update the query 215 to include an additional keyword “Cannel” because “Carmel” may be a detected relationship, being a city, between one or more Stanford faculty and one or more marathon runners. The updated query may then be used again in the search process either automatically or as approved by the user 15. This updated query may then be used in the next search session to generate new relationships. These new relationships may provide an additional keyword “robotic researcher”. A new query may then be generated having keywords “Stanford faculty”, “marathon runner”, “Carmel”, and “robotic researcher”. This new query may then be used again in the next search session. In this search session, the ranking of the items may be such that the search attribute corresponding to “marathon runner” becomes less relevant, being ranked the lowest. Accordingly, in the next search session, the keyword “marathon runner” is deleted and a new keyword “NSF investigator” is discovered. Finally, the keywords “Stanford faculty”, “Carmel”, “robotic researcher”, and “NSF investigator” lead to a single item corresponding to a “Professor John Steinbeck” who is the only person meeting all the 4 keywords, i.e., being a Stanford faculty, a robotic researcher, an NSF investigator, and living in Carmel.

The KB updater 620 updates the KB 270 using the enhanced search results. It may add new information to the KB 270. It may delete obsolete information from the KB 270. It may re-arrange the KB 270 such as re-grouping information items, assigning new scores, etc.

The user feedback analyzer 630 analyzes the user feedback, comments, or selection. It may use the user feedback to aid the query updater 610 and/or the KB updater 620. It is interfaced to the user interface 210. It may present the enhanced search results to the user 15 via the user interface 210. For example, it may produce a list of people who are both Stanford faculty and marathon runners and a list of marathon runners who live in Carmel. The user 15 may then rank the list by giving weights or scores to these items. These new rankings may then be used to update the query 215.

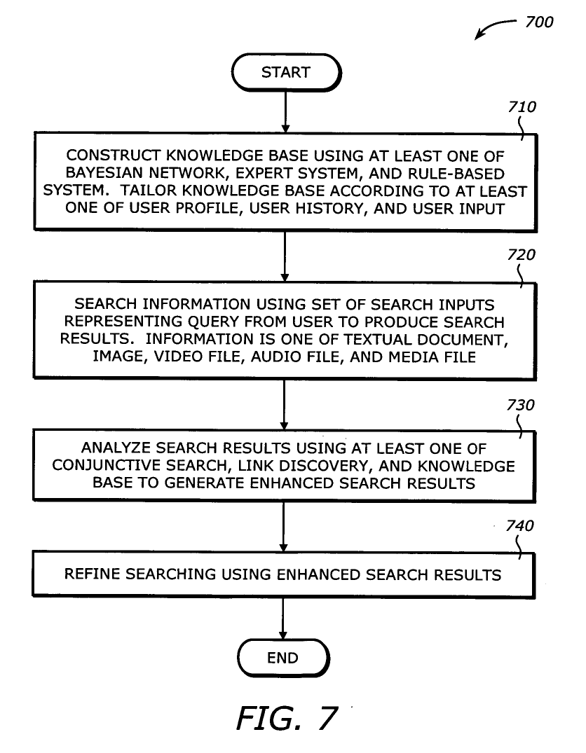

FIG. 7 is a flowchart illustrating a process 700 to perform information retrieval according to one embodiment of the invention.

Upon START, the process 700 constructs the knowledge base using at least one of a Bayesian network, an expert system, and a rule-based system (Block 710). The knowledge base may be constructed by tailoring the knowledge base according to at least one of user profile, user history, and user input. Then, the process 700 searches information using a set of search inputs representing a query from a user to produce a plurality of search results (Block 720). The information may be one of a textual document, an image, a video file, an audio file, and a media file. Next, the process 700 analyzes the search results using at least one of a conjunctive search, a link discovery, and a knowledge base to generate enhanced search results (Block 730). Then, the process 700 refines searching using the enhanced search results (Block 740). The process 700 is then terminated.

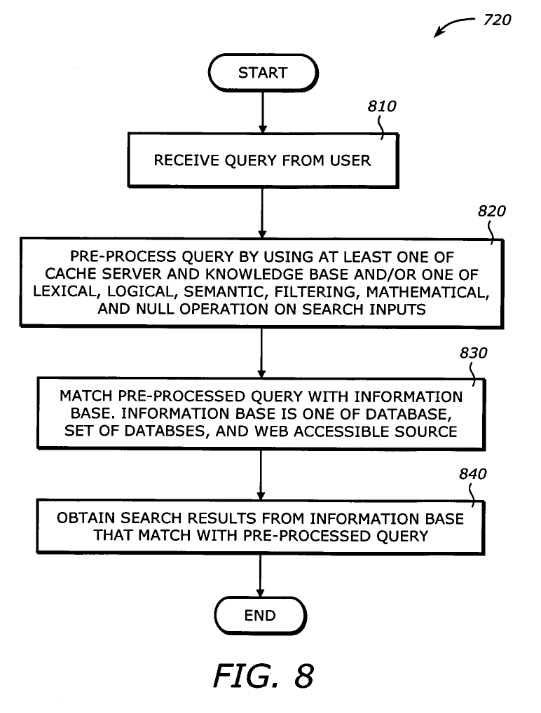

FIG. 8 is a flowchart illustrating the process 720 to search the information according to one embodiment of the invention.

Upon START, the process 720 receives the query from the user (Block 810). Next, the process 720 pre-processes the query (Block 820). The pre-processing may be performed using at least one of a cache server and the knowledge base. The pre-processing may also be performed using at least one of a lexical operation, a logical operation, a semantic operation, a filtering operation, a mathematical operation, and a null operation on the search inputs.

Then, the process 720 matches the pre-processed query with an information base (Block 830). The information base may be one of a database, a set of databases, and a Web accessible source. Next, the process 720 obtains the search results from the information base that match with the pre-processed query (Block 840). The process 720 is then terminated.

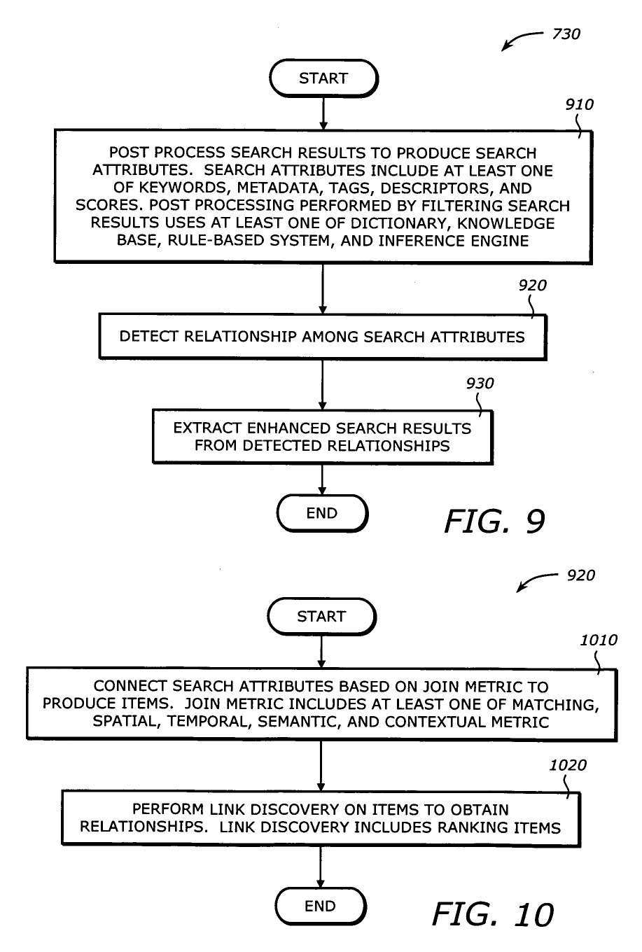

FIG. 9 is a flowchart illustrating the process 730 to analyze the search results according to one embodiment of the invention.

Upon START, the process 730 post processes the search results to produce search attributes (Block 910). The search attributes include at least one of keywords, metadata, tags, descriptors, and scores. The post processing may be performed by filtering the search results to produce the search attributes. The filtering may be done by filtering out items in the search results using at least one of a dictionary, the knowledge base, a rule-based system, and an inference engine.

Next, the process 730 detects relationships among the search attributes (Block 920). Then, the process 730 extracts the enhanced search results from the detected relationships (Block 930). The process 730 is then terminated.

FIG. 10 is a flowchart illustrating the process 920 to detect the relationships according to one embodiment of the invention.

Upon START, the process 920 connects the search attributes based on a join metric to produce items (Block 1010). Connecting the search attributes may be performed using at least one of a matching metric, a spatial metric, a temporal metric, a semantic metric, and a contextual metric. Next, the process 920 performs a link discovery on the items to obtain the relationships (Block 1020). The link discovery may be performed by ranking the items. The process 920 is then terminated.

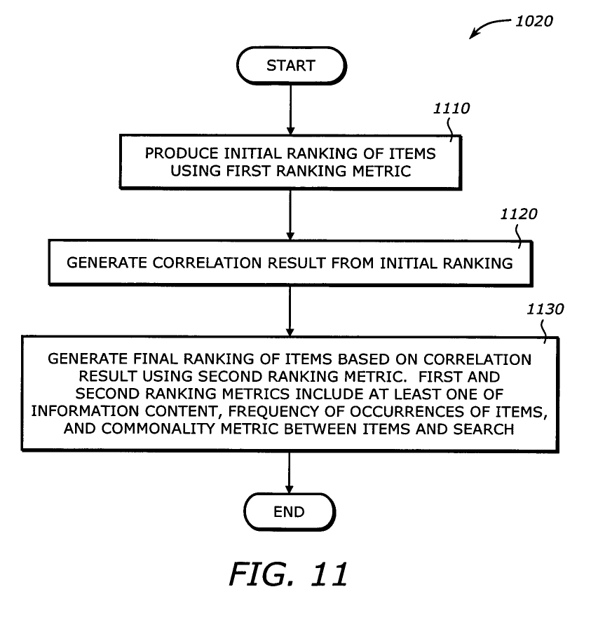

FIG. 11 is a flowchart illustrating the process 1020 to rank the items according to one embodiment of the invention.

Upon START, the process 1020 produces an initial ranking of the items using a first ranking metric (Block 1110). The first rank metric may include at least one of information content, a frequency of occurrences of the items, and a commonality metric between the items and the search. Next, the process 1020 generates a correlation result from the initial ranking (Block 1120). Then, the process 1020 generates a final ranking of the items based on the correlation result using a second ranking metric (Block 1130). The second ranking metric may include at least one of information content, a frequency of occurrences of the items, and a commonality metric between the items and the search.

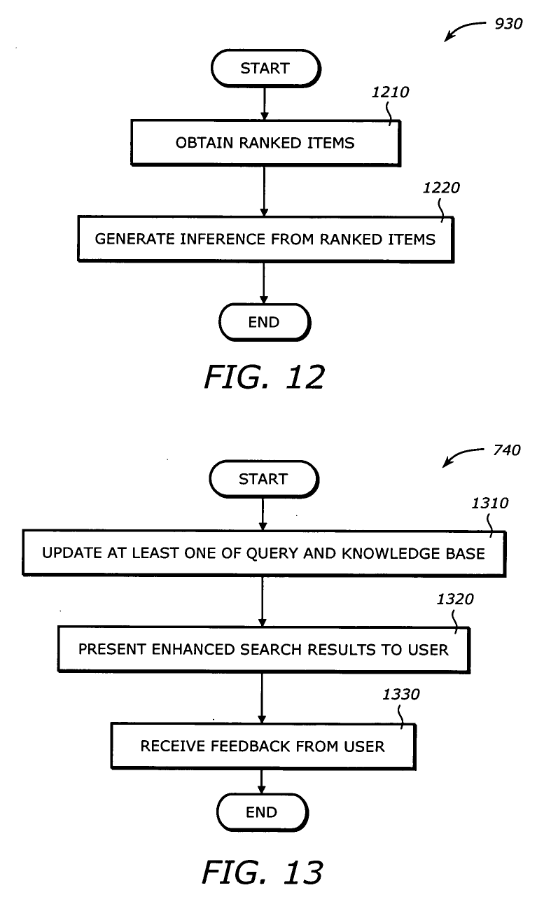

FIG. 12 is a flowchart illustrating the process 930 shown in FIG. 9 to rank the items according to one embodiment of the invention.

Upon START, the process 930 obtains the ranked items (Block 1210). Next, the process 1210 generates an inference from the ranked items (Block 1220). The process 930 is then terminated.

FIG. 13 is a flowchart illustrating the process 740 shown in FIG. 7 to refine searching according to one embodiment of the invention.

Upon START, the process 740 updates at least one of the query and the knowledge base (Block 1310). Next, the process 740 presents the enhanced search results to the user (Block 1320). This may be performed by using the GUI. Then, the process 740 receives feedback from the user (Block 1330). The process 740 is then terminated.

Elements of embodiments of the invention may be implemented by hardware, firmware, software or any combination thereof. The term hardware generally refers to an element having a physical structure such as electronic, electromagnetic, optical, electro-optical, mechanical, electromechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc. A block diagram may contain blocks or modules that describe an element, an item, a component, a device, a unit, a subunit, a structure, a method, a process, a function, an operation, a functionality, or a task, etc. A functionality or an operation may be performed automatically or manually.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
searching information using a set of search inputs representing a query from a user to produce a plurality of search results; and
analyzing the search results using at least one of a conjunctive search, a link discovery, and a knowledge base to generate enhanced search results.

2. The method of claim 1 wherein searching the information comprises:
receiving the query from the user;
pre-processing the query; and
matching the pre-processed query with an information base; and
obtaining the search results from the information base that match with the pre-processed query.

3. The method of claim 2 wherein pre-processing the query comprises:
pre-processing the query using at least one of a cache server and the knowledge base.

4. The method of claim 2 wherein pre-processing the query comprises:
performing at least one of a lexical operation, a logical operation, a semantic operation, a filtering operation, a mathematical operation, and a null operation on the search inputs.

5. The method of claim 1 wherein analyzing the search results comprises:
post processing the search results to produce search attributes;
detecting relationships among the search attributes; and
extracting the enhanced search results from the detected relationships.

6. The method of claim 5 wherein post processing the search results comprises:
filtering the search results, the filtered search results corresponding to the search attributes.

7. The method of claim 6 wherein filtering the search results comprises:
filtering out the search results using at least one of a dictionary, the knowledge base, a rule-based system, and an inference engine.

8. The method of claim 5 wherein detecting relationships comprises:
connecting the search attributes based on a join metric to produce items; and
performing a link discovery on the items to obtain the relationships.

9. The method of claim 8 wherein connecting the search attributes comprises:
connecting the search attributes using at least one of a matching metric, a spatial metric, a temporal metric, a semantic metric, and a contextual metric.

10. The method of claim 8 wherein performing the link discovery comprises:
ranking the items.

11. The method of claim 10 wherein ranking the items comprises:
producing an initial ranking of the items using a first ranking metric;
generating a correlation result from the initial ranking; and
generating a final ranking of the items based on the correlation result using a second ranking metric.

12. The method of claim 11 wherein one of the first and second ranking metrics includes at least one of information content, a frequency of occurrences of the items, and a commonality metric between the items and the search.

13. The method of claim 5 wherein search attributes include at least one of keywords, metadata, tags, descriptors, and scores.

14. The method of claim 10 wherein extracting the enhanced results comprises:
obtaining the ranked items.

15. The method of claim 14 wherein extracting the enhanced results further comprises:
generating an inference from the ranked items.

16. The method of claim 1 further comprising:
refining searching using the enhanced search results.

17. The method of claim 16 wherein refining searching comprises:
updating at least one of the query and the knowledge base.

18. The method of claim 17 wherein refining searching further comprises:
presenting the enhanced search results to the user; and
receiving feedback from the user.

19. The method of claim 1 further comprising:
constructing the knowledge base using at least one of a Bayesian network, an expert system, and a rule-based system.

20. The method of claim 19 wherein constructing the knowledge base comprises:
tailoring the knowledge base according to at least one of user profile, user history, and user input.

21. The method of claim 1 wherein the information is one of a textual document, an image, a video file, an audio file, and a media file.

22. The method of claim 2 wherein the information base is one of a database, a set of databases, and a Web accessible source.

23. An information retrieval system comprising:
a search engine to search information using a set of search inputs representing a query from a user to produce a plurality of search results; and
an analyzer coupled to the search engine to analyze the search results using at least one of a conjunctive search, a link discovery, and a knowledge base to generate enhanced search results.

24. The system of claim 23 wherein the search engine comprises:
a user interface to receive the query from the user;
a pre-processor coupled to the user interface to pre-process the query; and
a matcher coupled to the pre-processor to match the pre-processed query with an information base, the matcher obtaining the search results from the information base that match with the pre-processed query.

25. The system of claim 23 wherein the analyzer comprises:
a post processor to post process the search results to produce search attributes;
a relationship detector coupled to the post processor to detect relationships among the search attributes; and
an extractor coupled to the relationship detector to extract the enhanced search results from the detected relationships.

26. The system of claim 25 wherein the relationship detector comprises:
an attribute connector to connect the search attributes based on a join metric to produce items; and
a link discovery processor coupled to the attribute connector to perform a link discovery on the items to obtain the relationships.

27. The system of claim 23 further comprising:
a search refiner coupled to the analyzer to refine searching using the enhanced search results.

28. An article of manufacture comprising:
a machine-accessible medium including data that, when accessed by a machine, cause the machine to perform operations comprising:
searching information using a set of search inputs representing a query from a user to produce a plurality of search results; and
analyzing the search results using at least one of a conjunctive search, a link discovery, and a knowledge base to generate enhanced search results.

29. The article of manufacture of claim 28 wherein the data causing the machine to perform searching information comprises data that, when accessed by a machine, cause the machine to perform operations comprising one of:
receiving the query from the user;
pre-processing the query; and
matching the pre-processed query with an information base; and
obtaining the search results from the information base that match with the pre-processed query.

30. The article of manufacture of claim 21 wherein the data causing the machine to perform analyzing comprises data that, when accessed by a machine, cause the machine to perform operations comprising:
post processing the search results to produce search attributes;
detecting relationships among the search attributes; and
extracting the enhanced search results from the detected relationships.
